(19) United States
(12) Patent Application Publication
(10) Pub. No.: US 2010/0191661 A1
(43) Pub. Date: Jul. 29, 2010

(54) METHODS AND SYSTEMS TO DETECT AND REPORT FRAUD IN REAL TIME

(76) Inventors: Daniel L. Pritchett, San Jose, CA (US); Dhanurjay A.S. Patil, Belmont, CA (US); Wayne Fenton, Sunnyvale, CA (US); Mark A. Sikes, San Jose, CA (US); Sharad Murthy, Fremont, CA (US); Philip Wright, Austin, TX (US); Jaya Kolhatkar, Emerald Hills, CA (US)

Correspondence Address: SCHWEGMAN, LUNDBERG & WOESSNER/EBAY, P.O. BOX 2938, MINNEAPOLIS, MN, 55402, US

(21) Appl. No.: 12/625,322

(22) Filed: Nov. 24, 2009

Related U.S. Application Data
(60) Provisional application No. 61/117,532, filed on Nov. 24, 2008.

(51) Int. Cl. G06Q 99/00; G06Q 10/00; G06Q 40/00; G06F 15/16

(52) U.S. Cl. 705/318; 709/217

(57) ABSTRACT

Methods and Systems of detecting and reporting fraud in real-time are described. The system receives an event, over a network, from a first on-line transaction processing platform. The event includes a first identity identifier that identifies a first identity and information that identifies a first activity performed by the first identity. The system generates reporting information based on the event. The reporting information includes a first score that is associated with the first identity. The first score is a measure of a likelihood that the first identity has performed a fraudulent activity. Finally, the system communicates the first score, over the network, to the first on-line transaction processing platform. The system communicates the first score in response to receiving the event.

### RELATED APPLICATIONS

This application claims the priority benefits of U.S. Provisional Application No. 61/117,532, filed Nov. 24, 2008 which is incorporated herein by reference.

### TECHNICAL FIELD

An embodiment relates generally to the technical field of fraud detection and, in one example embodiment, to methods and systems to detect and report fraud in real time.

### BACKGROUND

On-line transaction processing platforms may be susceptible to fraudulent activity. Indeed, fraudsters are continually developing new and creative tactics to separate a rightful owner from their property. Such tactics may continue undetected for a considerable amount of time to the detriment of honest commerce.

### BRIEF DESCRIPTION OF THE DRAWINGS

An embodiment of the present disclosure is illustrated by way of example and not limitation in the figures of the accompanying drawings, in which like references indicate similar elements and in which:

FIG. 1A is a block diagram illustrating a system, according to one embodiment, to detect and report fraud in real time;

FIG. 1B is a block diagram illustrating a graph, according to one embodiment;

FIG. 1C is a block diagram illustrating a system, according to one embodiment, to detect and report fraud in real time;

FIG. 2 is a block diagram illustrating a fraud detection system, according to one embodiment;

FIG. 3 is a block diagram illustrating an event, according to one embodiment;

FIG. 4 is a block diagram illustrating an event router, according to one embodiment;

FIG. 5 is a block diagram illustrating a scalar scorer module, according to one embodiment;

FIG. 6A is a block diagram illustrating commerce network information, according to one embodiment;

FIG. 6B is a block diagram illustrating link information, according to one embodiment;

FIG. 7 is a block diagram illustrating metric information, according to one embodiment;

FIG. 8 is a block diagram illustrating network information, according to one embodiment;

FIG. 9 is a block diagram illustrating reporting information, according to one embodiment;

FIGS. 10A-10B are block diagrams illustrating a method, according to one embodiment, to detect and report fraud in real time;

FIG. 11 is a user interface, according to one embodiment;

FIG. 12 is a block diagram of a machine, according to one embodiment.

### DETAILED DESCRIPTION

Methods and systems to detect and report fraud in real time are described. In the following description, for purposes of explanation, numerous specific details are set forth in order to provide a thorough understanding of the present disclosure. It will be evident, however, to one skilled in the art that the present disclosure may be practiced without these specific details.

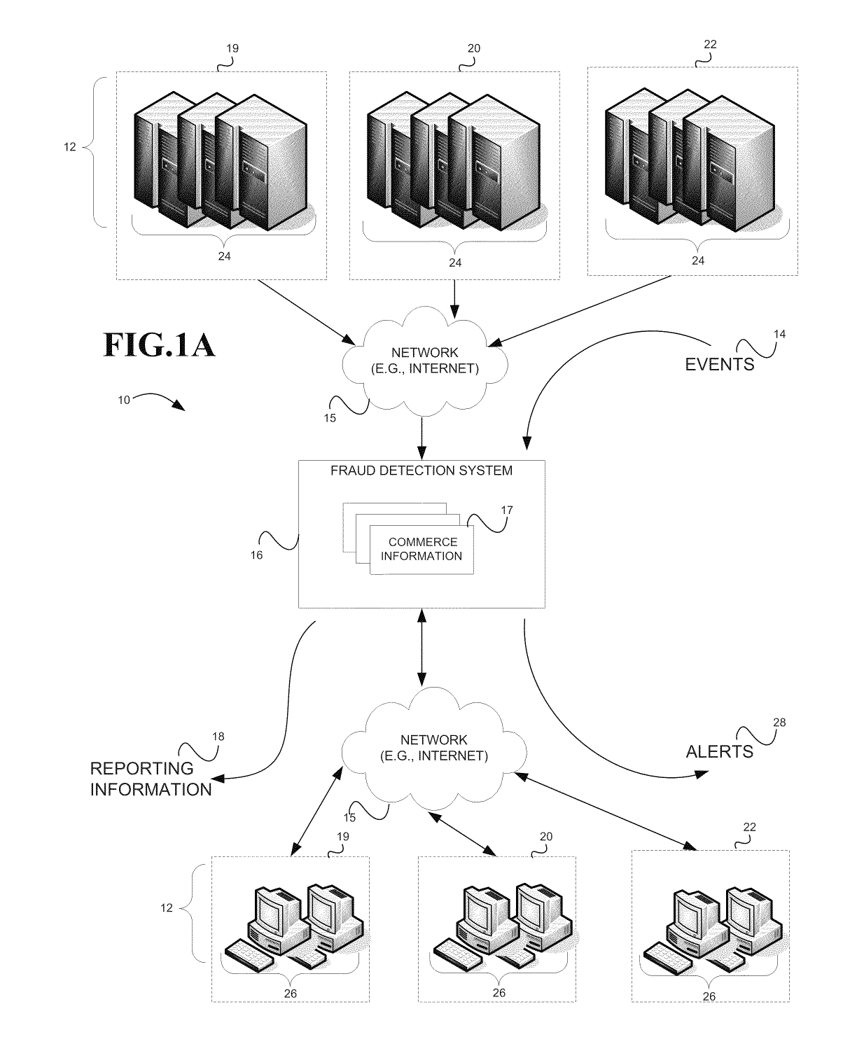

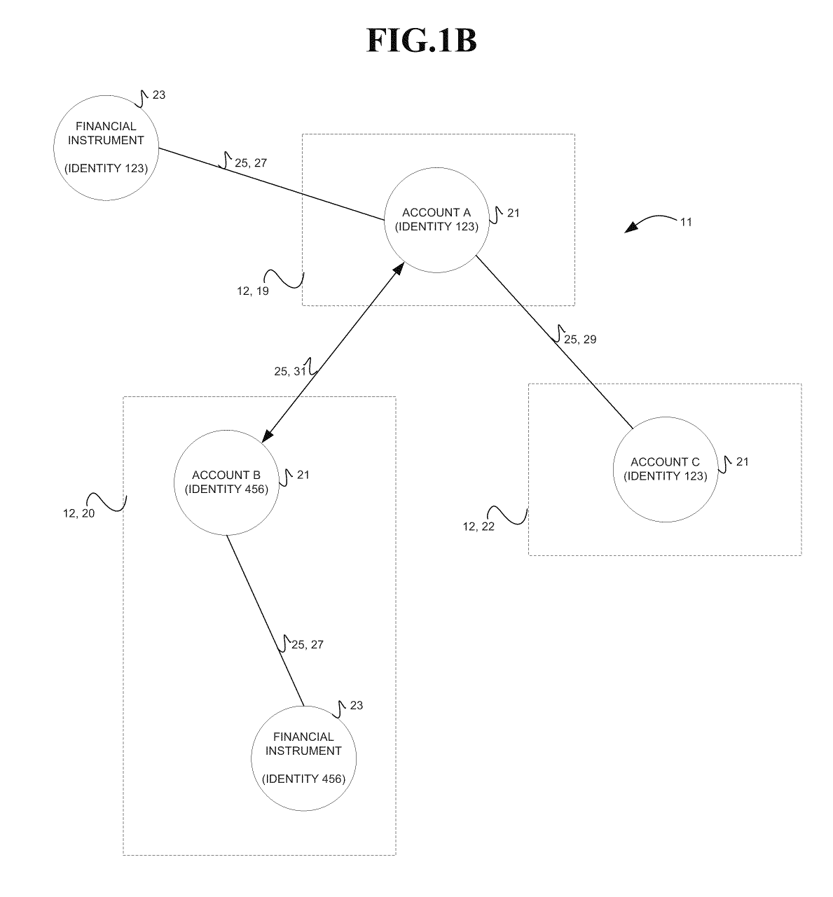

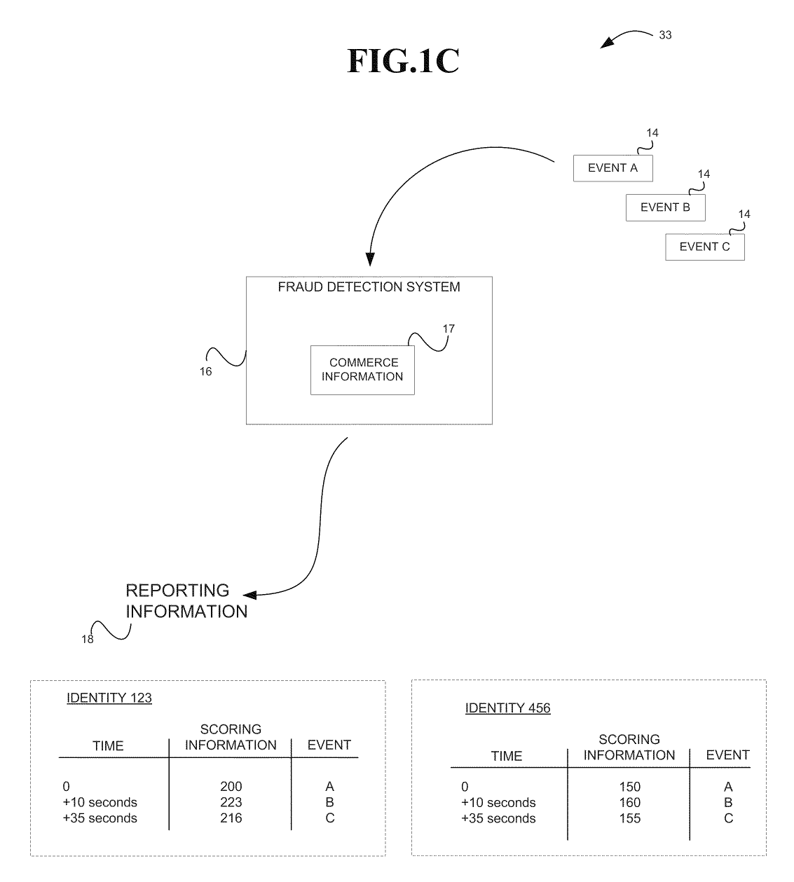

FIG. 1A is a block diagram illustrating a system 10, according to one embodiment, to detect and report fraud in real time. The system 10 is shown to include three on-line transaction processing platforms 12 that communicate events 14 over a network 15 (e.g., Internet, WAN, LAN, Wireless, etc.) to the fraud detection system 16. The events include activity information that may describe an activity performed by an identity (e.g., natural or legal person). The fraud detection system 16 processes the events 14 to generate commerce information 17, that, in turn, is utilized by the fraud detection system 16 to generate reporting information 18 that is continuously communicated over the network 15 back to the respective on-line transaction processing platforms 12. The reporting information 18 may be generated in real time and continuously updated in response to receipt of the events 14 at the fraud detection system 16. In one embodiment, the on-line transaction processing platforms 12 may be independently controlled and/or operated by different legal entities. In one embodiment the different legal entities may be independently controlled. For example, the legal entities 19, 20, and 22 may respectively be embodied as eBay of San Jose Calif., PayPal of San Jose Calif., and VISA Inc., of Wilmington, Del.

The on-line transaction processing platforms 12 may include multiple servers, databases, and other online processing equipment (not shown) that provides e-commerce services for users that operate client machines (not shown) that are connected over the network 15 to the on-line transaction processing platforms 12. The on-line transaction processing platforms 12 may further include event generating machines 24 that generate the events 14 that are descriptive of activities performed by identities. The activities may relate to accounts, financial instruments and transactions processed by the on-line transaction processing platforms 12. The on-line transaction processing platforms 12 may further include one or more monitoring machines 26. The monitoring machines 26 may be operated by human agents or automated agents (e.g., robots). The human agents or automated agents may utilize the reporting information 18 that is continually received in real-time to identify one or more identities that are suspected of fraudulent activity and to restrict accounts associated with such identities from further activity.

The fraud detection system 16 is further shown to communicate alerts 28 over the network 15 to the monitoring machines 26. For example, the fraud detection system 16 may identify an identity that is associated with a score that has increased over a first alert threshold or dropped below a second alert threshold. In one embodiment, the first and second alert thresholds may be collapsed into a single alert threshold. In one embodiment the alert threshold may be configurable. Further, for example, the fraud detection system 16 may respond to the score crossing the threshold by communicating the alert to the appropriate monitoring machines 26. For example, the alert may be communicated as an interface that includes an identity identifier, a score, and a warning that the probability score has exceeded or dropped below alert threshold.

While the system 10 shown in FIG. 1A employs a client-server architecture, the present disclosure is of course not limited to such an architecture, and could equally well find application in a distributed, or peer-to-peer, architecture system.

FIG. 1B is a block diagram illustrating a graph 11, according to an embodiment. The graph 11 may be used to depict the commerce information 17, as shown on FIG. 1A. The graph 11 may include nodes in the form of one or more accounts 21 or one or more financial instruments 23. The accounts 21 may be hosted by on-line transaction processing platforms 12 that are operated by different legal entitles 19, 20, 22. The graph 11 may be generated based on a single account 21. Such an account may be identified as a seed account. For example, the illustrated graph 11 is shown to include a seed “Account A.” The graph 11 may further include links 25 that connect other nodes to the “Account A.” The accounts and financial instruments (e.g., nodes) may be associated with an identity (e.g., “identity 123,” “identity 456”) in the form of a natural or legal person that, in one embodiment, bears legal responsibility for the account or financial instrument.

The account 21 may be utilized to conduct electronic commerce on the on-line transaction processing platform 12. To this end the account 21 may be associated with identity information (e.g., social security number) that is used to anchor the account to the identity responsible for the account.

The financial instrument 23 may be used to source or sink a transfer of value (e.g., monetary value, proprietary currency, etc.). For example, the financial instrument 23 may include a credit card, debit card, or some other financial instrument 23 (e.g., VISA, MASTERCARD, AMEX, etc.). The financial instrument 23 may be associated with identity information, as previously described. In one embodiment, the nodes (e.g., accounts, financial instruments) may or may not be supported by the on-line transaction processing platforms 12 included in the system 10. For example, an event 14 may be received that describes a transaction that includes a first account 21 that is hosted by an on-line transaction processing platform 12 included in the system 10 and a second account 21 that is not hosted by any of the on-line transaction processing platforms 12 that are included in the system 10.

The links 25 may represent a relationship between two accounts 21 or a relationship between an account 21 and a financial instrument 23. The links 25 may, for example, include an asset link 27, a user link 29, and a transaction link 31. The asset link 27 (no arrows) may identify a link between a financial instrument 23 and an account 21. The asset link 27 links a financial instrument 23 and an account 21 that are respectively associated with the same identity. For example, the asset link 27 may represent a transfer of funds from “Joe's” financial instrument 23 (e.g., credit card) to “Joe's” account 21 or a transfer of funds from “Joe's” financial instrument 23 to “Joe's” account 21 (e.g., chargeback).

The user link 29 (no arrows) may identify a link between two accounts 21 associated with the same identity. For example, the user link 29 may represent a transfer of funds from an account 21 associated with “Joe” to another account 21 associated with the same “Joe” or a transfer of funds in the reverse direction.

The transaction link 31 may identify a transaction between two accounts 21 that are respectively associated with different identities. For example, the transaction link 31 may represent a transfer of funds from an account 21 associated with an identity “Joe” to an account 21 associated with an identity “Jane” or a transfer of funds in the reverse direction. A transaction may include an exchange between two persons (e.g., natural or legal). For example, the transaction may include an exchange of goods or services for a national currency or proprietary currency (e.g., travel miles). The transaction link 31 may link accounts 21 that are hosted on the same on-line transaction processing platforms 12. For example, the transaction link 31 may link an account 21 associated with an identity “Joe” to an account 21 associated with an identity “Jane” that are hosted on a single on-line transaction processing platform 12 (e.g., dedicated to supporting auctions or retail sales). In another example, the accounts 21 may be hosted by different on-line transaction processing platforms 12. For example, the account 21 associated with the identity “Joe” may be hosted on a first on-line transaction processing platform 12 and the account 21 associated with the identity “Jane” may be hosted on a second on-line transaction processing platform 12.

FIG. 1C is a block diagram illustrating a system 33, according to one embodiment, to detect and report fraud in real time. The system 33 corresponds to the system 10 in FIG. 1A and, accordingly, the same or similar references have been used to indicate the same or similar features unless otherwise indicated. The system 33 is shown to include a fraud detection system 16 that receives and processes events 14 to generate commerce information 17 that is used to generate, in real time, reporting information 18. The events 14 may include an identity identifier that identifies an identity and information that describes an activity performed by the identity. The commerce information 17 may be embodied as link information, metric information, and network information, as described later in this document. The reporting information 18 may for example include scoring information (e.g., scores) for one or more identities.

The reporting information 18 may be generated in response to receipt of a single event. For example, FIG. 1C illustrates reporting information 18 for an identity “123” that includes a score. The score may be updated for the identity “123” in response to receiving and processing of a single event. For example, as illustrated, the identity “123” is associated with a score of “200” that was generated in response to fraud detection system 16 processing an event “A” at time “0.” Further, as illustrated, the fraud detection system 16 updates the score for the identity “123” to “223” in response to processing an event “B” at time “+10 seconds” and again updates the score to “216” in response processing an event “C” at time “+35 seconds.”

The reporting information 18 may further be generated for multiple identities in response to receipt of a single event. For example, FIG. 1C illustrates scores for an identity “123” and an identity “456” that are generated in response to a single event. For example, as illustrated, the identity “123” is associated with a score of “200” and the identity “456” is associated with a score of “150” that were both generated in response to fraud detection system 16 processing a single event “A” at time “0.” Further for example, the scores for both identities are illustrated as generated by the fraud detection system 16 in response to receiving and processing the subsequent events “B” and “C.”

The system 33 may be contrasted with prior art systems that do not update reporting information 18 in real time. Such systems process successive batches of events to generate and report scores that are static (e.g., not changing in real time in response to receipt of an event). Moreover, the time between the batched reporting of scores represents a period during which fraudulent activity may go undetected. Reporting a snapshot of scores is a deficiency of the prior art that may be costly to the on-line transaction processing platforms 12. In addition, the prior art systems report scores that are not based on commerce information 17 that includes multiple nodes (e.g., financial instruments, accounts). Rather, such prior art systems utilize fraud detection mechanisms that focus on a single account and links associated with the single account.

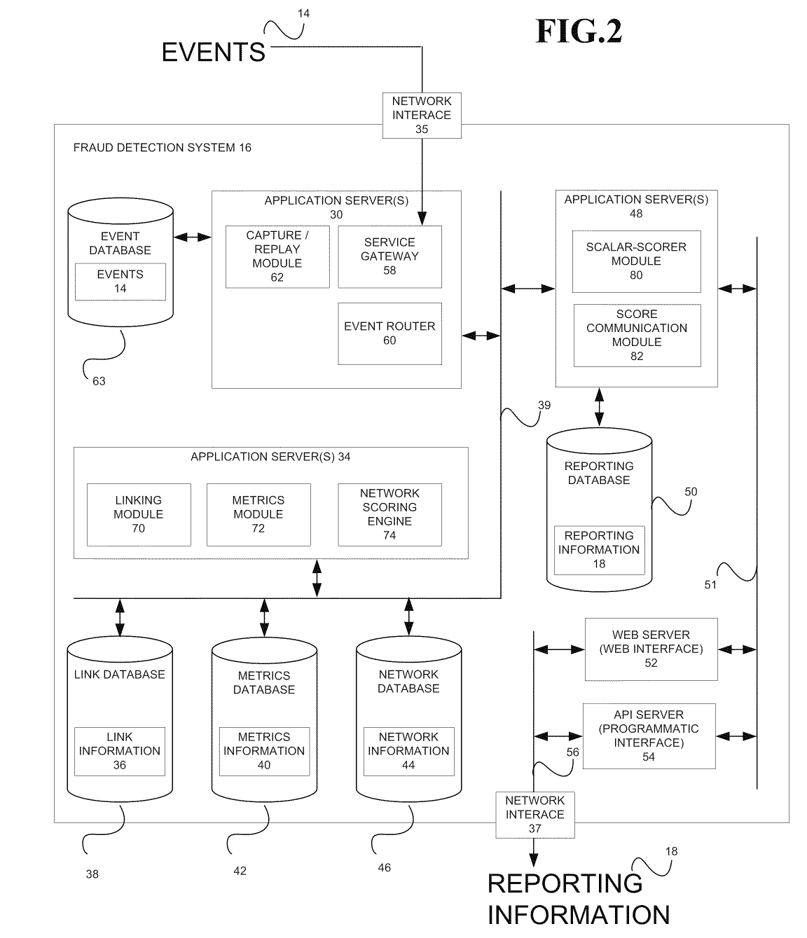

FIG. 2 is a block diagram illustrating a fraud detection system 16, according to one embodiment. The fraud detection system 16 is shown to include one or more application servers 30 that receive the events 14 via a network interface 35. In one embodiment the events 14 may be embodied as data packets containing extensible markup language (XML) that are communicated over the network 15 utilizing the Internet Protocol (IP) and the Transport Control Protocol (TCP).

The application servers 30 may process the events 14 and route the events 14 over a bus 39 to application servers 34 and 48 for further processing. The application servers 30 and 34 may process the events 14 to generate the commerce information 17, as shown in FIG. 1. The commerce information 17 includes the results of the processing of the events 14 that have been received by the fraud detection system 16 over a predetermined period of time. Accordingly, the commerce information may be considered a summary of the processing of the events 14 for multiple identities over a predetermined period of time. The fraud detection system 16 may store the commerce information 17 as link information 36 in a link database 38, metrics information 40 in a metrics database 42, and network information 44 in a network database 46.

The fraud detection system 16 is further shown to include one or more application server(s) 48. The application server(s) 48 may retrieve the link information 36 from the link database 38, the metrics information 40 from the metrics database 42, and the network information 44 from the network database 46. The application server(s) 48 may process the link information 36, the metrics information 40 and the network information 44 to generate and store reporting information 18 in a reporting database 50. The application server 48 further communicates the reporting information 18 over a bus 51 to a web server 52 and/or an applications programming interface (API) server 54. The web server 52 includes a web interface that is used to communicate the reporting information 18 in the form of an interface to monitoring machines 26 (e.g., client machines) that are coupled to the on-line transaction processing platforms 12. In one embodiment the interface may include a user interface that displays the reporting information 18 to human agents that operate the monitoring machines 26. In another embodiment the interface may include an audio interface that announces the reporting information 18 to the human agent that operates the monitoring machines 26. The API server 54 includes an application programming interface that is used to communicate the reporting information 18 to the monitoring machines 26 (e.g., client machines). The application programming interface may include a set of functions, procedures or classes that an operating system, library or service provides to support requests made by computer programs hosted by the monitoring machines 26.

The application server 30 is shown to include a service gateway 58, an event router 60, and a capture/replay module 62. The service gateway 58 may perform load balancing operations and communicate the event 14 to a capture/replay module 62 that stores the event 14 in an event database 63. The capture replay module 62 may further be used to retrieve and replay the events 14 on a monitor (not shown) that is connected to the fraud detection system 16. In one embodiment, the capture/replay module 62 may be used to simulate and diagnose fraudulent activity by replaying the events 14 that are captured during a period of time that is received by the fraud detection system 16. The service gateway 58 may further communicate the event 14 to the event router 60 that, in turn, communicates the event 14 over a bus 39 to the application servers 34 and 48.

The application server 34 is shown to include a linking module 70, a metrics module 72 and network scoring engine 74. The respective modules 70, 72, and 74 process the event 14 and further update the databases 38, 42, and 46. The linking module 70 may processes the event 14 to generate or update the link information 36 stored in the link database 38. The metrics module 72 may processes the event 14 to generate or update the metrics information 40 in the metrics database 42. The network scoring engine 74 may processes the event 14 to generate or update the network information 44 that is stored in the network database 46. The network scoring engine 74 may further use the commerce information 17 to generate a graph 11 depicting a seed account 21 and links 25 connecting the seed account 21 to other nodes on the graph 11, as previously described on FIG. 1B. The network scoring engine 74 utilizes the graph 11 to generate reporting information 18, as described further in this document.

The application server 48 is shown to include a scalar-scorer module 80 and score communication module 82. The scalar-scorer module 80 retrieves the link information 36, the metrics information 40, and the network information 44. The scalar-scorer module 80 processes the link information 36, metrics information 40, and network information 44 to generate the reporting information 18 that is stored in the reporting database 50.

The score communication module 82 retrieves the reporting information 18 from reporting database 50 and identifies whether the reporting information 18 has changed for a particular identity. In response to detecting a change in the reporting information 18 for the identity, the score communication module 82 may communicate the reporting information 18 over the bus 51 to the web server 52 or the API server 54 that, in turn, communicates the reporting information 18 over the bus 56 via the network interface 37 onto the network. In a similar manner, the score communication module 82 may detect and communicate an alert.

While the fraud detection system 16 shown in FIG. 2 employs multiple application servers 30, 34, 48, 52, and 54 it will be appreciated that each of the modules/engines may run on a single server or more servers than presently illustrated.

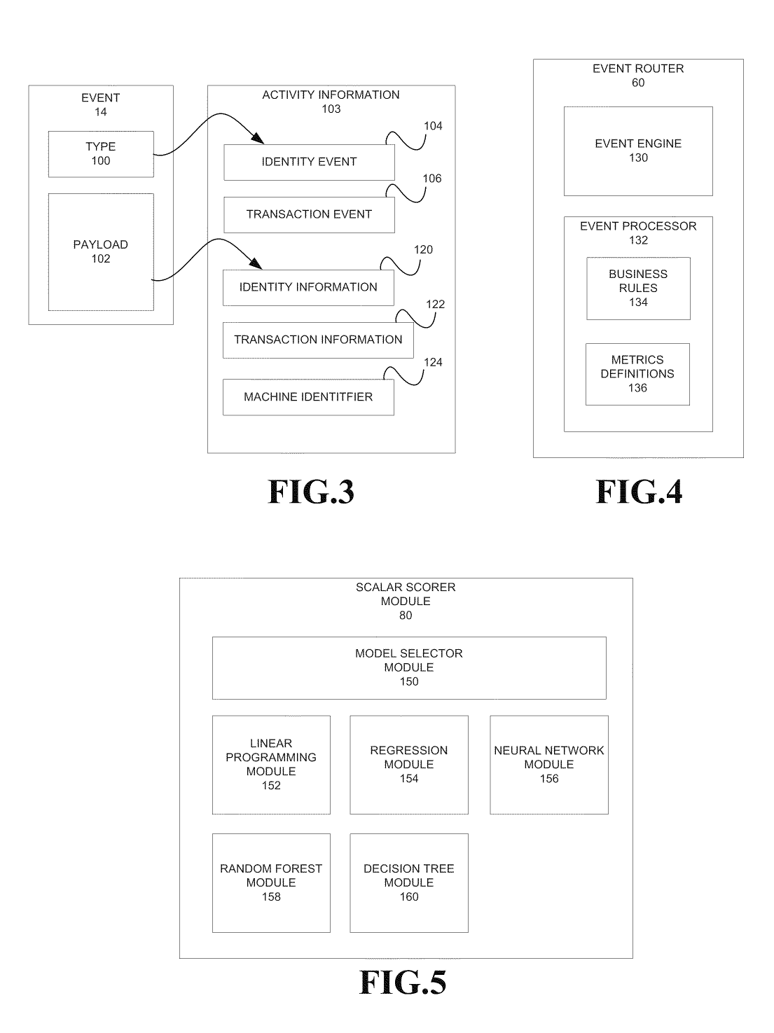

FIG. 3 is a block diagram illustrating an event 14, according to one embodiment. The event 14 is shown to include activity information 103 that may describe an activity performed by an identity. The activity information 103 includes a type 100 and a payload 102. The event 14 may be communicated from an on-line transaction processing platform 12 and received by the fraud detection system 16. In one embodiment, the payload 102 may be used to store an identifier that identifies the transaction processing platform 12 that generated and communicated the event 14. Turning to the event 14, the type 100 stores the type of event. For example, the type 100 may include a type identifier that identifies an identity event 104 or a transaction event 106. The payload 102 may include identity information 120, transaction information 122, and a machine identifier 124.

The identity event 104 may be received in response to an activity that is associated with a financial instrument or an account and is performed by an identity. For example, an identity may use a credit card for the first time or open an account 21. Accordingly, the receipt of the identity event 104 may cause the addition of a node (e.g., financial instrument, account 21) to a graph 11. Further for example, the identity event 104 may cause the addition of a financial instrument to a graph 11. Conversely, the identity event 104 may be used to delete a node from a graph 11. The identity event 104 may be associated with a payload 102 that includes identity information 120 that is associated with a node on a graph 11. The identity may enter or update identity information 120 on an on-line transaction processing platform 12. The identity information may include a social security number, a drivers license number, a credit card number, a bank account number, a brokerage account number or any other identity identifier that uniquely identifies a person responsible for the account.

The identity event 104 may further be associated with a payload 102 that includes a machine identifier 124. The machine identifier 124 may be used to uniquely identify a machine on the network 15 that was used to access the account or financial instrument. For example, the machine identifier 124 may identify a machine that was used to update identity information 120 for a financial instrument or an account.

The transaction event 106 may be received in response to a transaction performed by an identity. For example, an identity may buy an item or win an auction on an on-line transaction processing platform 12 to cause the on-line transaction processing platform 12 to communicate the transaction event 106 to the fraud detection system 16. The transaction event 106 may be used to add a transaction link 31 that links two accounts 21. The transaction event 106 may be associated with a payload 102 that includes transaction information 122 and one or more machine identifiers 124. The transaction information 122 may be descriptive of a transfer of money from a first account to a second account, goods or services transacted, and a promise to deliver the good or services. The machine identifier 124 may be used to uniquely identify machines on the network 15 that were operated to execute the transaction.

FIG. 4 is a block diagram illustrating an event router 60. The event router 60 may include an event engine 130 and an event processor 132. The event router 60 may be used to process incoming events 14. The event router 60 may identify the type 100 of incoming event 14, and apply the appropriate business rules 134 and metrics definitions 136 to the event 14. The event router 60 may also route the event 14 to the link module 70, the metrics module 72, the network scoring engine 74 and/or the scalar scorer module 80. The event router 60 may also identify whether the link information 36, the metric information 40 or the network information 44 has been updated in response to the processing of the event 14.

The business rules 134 are utilized to process the types 100 and the payload 102 in the incoming events 14. Application of the business rules 134 results in generating the link information 36 and communicating the link information 36 to the linking module 70. Application of the business rules 134 further results in generating the metrics information 40 and communicating the metric information 40 to the metrics module 72.

The event engine 130 and the event processor 32 are functionally decoupled to achieve efficiency in responding to newly detected fraudulent activity. The event engine 130 may, for example, be encoded in Java language without regard to the semantics of the event 14. The event processor 132, on the other hand, may be maintained and updated by analysts who, without knowledge of the Java Programming Languages or other sophisticated computer science knowledge, may quickly generate the business rules 134 and metrics definitions 136 to process the semantic information in the event 14. Accordingly, an analyst who analyzes and studies fraud patterns may quickly add, delete or tweak the business rules 134 and/or metrics definitions 136 to adapt the fraud detection system 16 to detect and communicate reporting information 18 on a new and highly dynamic fraudulent activity. Accordingly, the decoupling of the event engine 130 functionality from the event processor 132 empowers an analyst to quickly author or modify the business rules 134/metrics definitions 136 to detect and restrict fraudulent activity.

The events 14 may include a multitude of variables that are analyzed by the analysts. A relatively small subset of those variables may, at any one time, predict fraudulent activity. Further, a variable that predicts fraudulent activity at one time may stop being predictive of fraudulent activity at another time. Accordingly, an analyst continually updates the business rules 134 and metric definitions 136 to retrieve variables from the events 14 that are predictive of the present fraudulent activity and to cause the storage of such variables as the link information 36 and the metric information 40.

FIG. 5 is a block diagram illustrating a scalar scorer module 80, according to one embodiment. The scalar-scorer module 80 may include a model selector module 150. The model selector module 150 may utilize the event type 100 and the payload 102 in the event 14 to select one or more models to process the event 14. The models may be embodied as a linear programming module 152, a regression module 154, a neural network module 156, a random forest module 158, or a decision tree module 160. In one embodiment, the models 152, 154, 156, 158, 160 may be configured by an analyst to detect and report a new type of fraudulent activity. In one embodiment, the models 152, 154, 156, 158, and 160 may access the metrics information 40 in the metrics database 42 and/or the linking information 36 in the link database 38 and/or the network information 44 in the network database 46 to process the event 14. Execution of the modules 152, 154, 156, 158, and 160 may result in generating/updating reporting information 18 based on a single event 14. Further, the models 152, 154, 156, 158, and 160 may process a single event 14 to generate/update reporting information 18 associated with one or multiple identities.

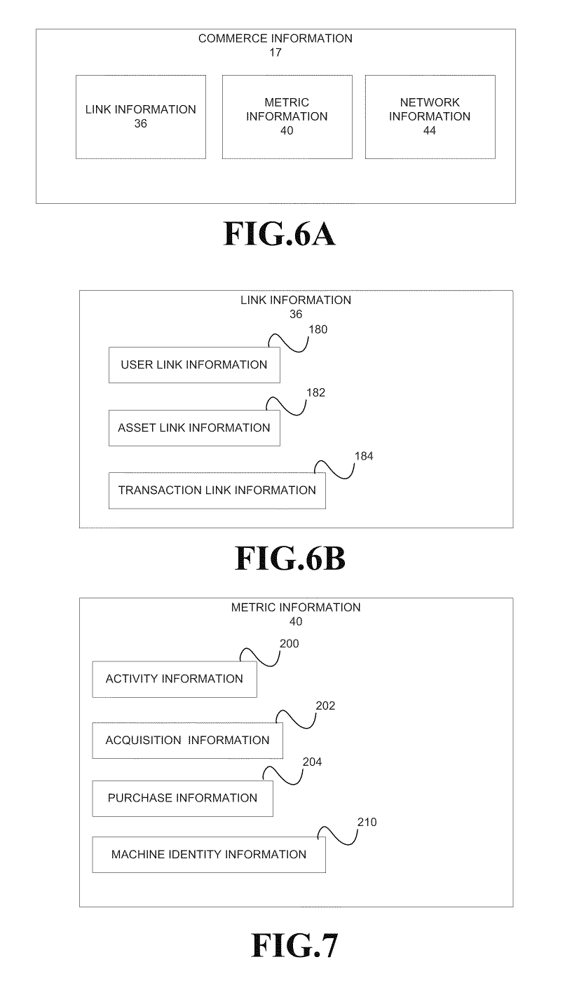

FIG. 6A is a block diagram illustrating commerce information 17, according to one embodiment. The commerce information 17 includes the results of the processing of events that have been received by the fraud detection system over a predetermined period of time. Accordingly, the commerce information 17 may be considered a summary of the processing of the events for multiple identities over a predetermined period of time. The commerce information 17 may be stored as link information 36 on the database 38, metric information 40 on the database 42 and network information 44 on the database 46, as described below. The commerce information 17 summarizes the activity information 103 that is received in events 14 for all identities that perform activities on the on-line transaction processing platforms. Accordingly, the link information 36, metric information 40, network information 44 are stored according to identities.

FIG. 6B is a block diagram illustrating link information 36, according to one embodiment. The link information 36 may include user link information 180, asset link information 182, and transaction link information 184. The user link information 180 may store information for the previously described user link 29. For example, the user link information 180 may store an identity identifier to identify the person (e.g., natural or legal) that is responsible for the account, a first account identifier, a second account identifier, a first platform identifier that identifies a first transaction processing platform 12 that hosts the first account, and a second platform identifier that identifies a second transaction processing platform 12 that hosts the second account.

The asset link information 182 may store information for the previously described asset link 27. For example, the asset link information 182 may include an identity identifier, an account identifier, a financial instrument identifier, a first platform identifier that identifies a first transaction processing platform 12 that hosts the account, and a second platform identifier that identifies a second transaction processing platform 12 that hosts the financial instrument. The asset link information 182 may further include an account balance, an account limit, and a history of recent transactions associated with the account. The asset link information 182 may further include a financial instrument balance, a financial instrument limit, and a history of recent transactions associated with the financial instrument.

The transaction link information 184 may store information for the previously described transaction link 31. For example, the transaction link information 184 may store a first identity identifier that identifies a first user who is a buyer in a sale or a bidder in an auction, a first account identifier that identifies an account associated with the first user and a first platform identifier that identifies a first transaction processing platform 12 that hosts the first account. Further, the transaction link information 184 may also store a second identity identifier that identifies a second user who is a seller in a sale or a seller in an auction, a second account identifier that identifies an account associated with the second user and a platform identifier that identifies a transaction processing platform 12 that hosts the second account. The transaction link information 184 further includes a transaction amount.

FIG. 7 is a block diagram illustrating metric information 40, according to an embodiment. Metric information 40 is shown to include activity information 200, acquisition information 202, purchase information 204, and machine identity information 210. The activity information 200 may describe an activity that was performed in relation to an identity. For example, the activity information 200 may store an identity identifier, and transaction information that describes a transaction including an amount transacted, an update or generation of anchoring information, a registration of a new account, a closing of an existing account, or any other activity that is performed on an on-line transaction processing system 12.

The acquisition information 202 may be used to store a description of a product or service that is acquired in a transaction by an identity. For example, the acquisition information 202 may include an identity identifier and an ISBN number of a book or a product number of an electronic device.

The purchase information 204 may be used to store a value or amount of money paid to acquire the product or service. For example, the purchase information 204 may include an identity identifier and a numerical value that represents monetary value.

The machine identity information 210 may be used to store the identity of a machine(s) that was used to access an account 21, execute a transaction, or access a financial instrument. For example, the machine identity information 210 may include a machine identifier, an account identifier, a transaction identifier, and a financial instrument identifier.

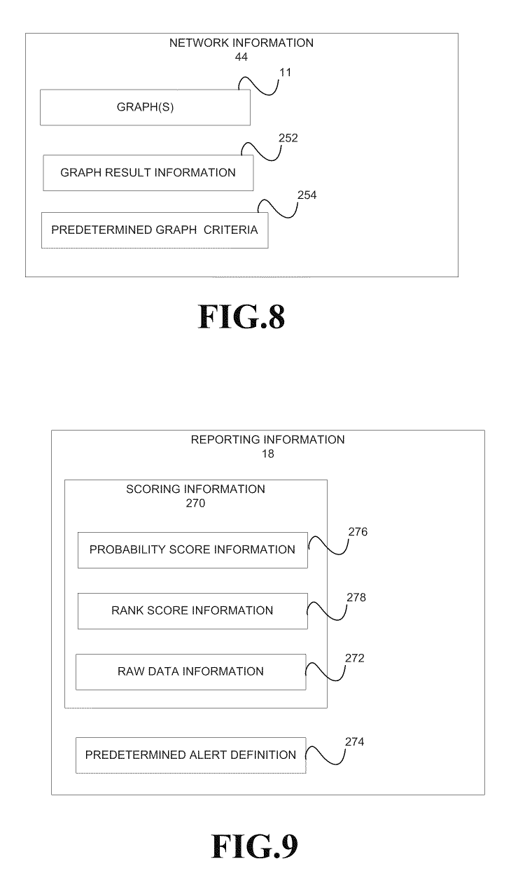

FIG. 8 is a block diagram illustrating network information 44, according to an embodiment. The network information 44 may be generated by the network scoring engine 74 and/or the event processor 32. The network information 44 may be stored on the network database 46. The network information 44 may include one or more graphs 11, as illustrated on FIG. 1B, graph result information 252 and predetermined graph criteria 254. The graph 11 may be generated in response to the network scoring engine 74 receiving an event 14. The graph 11 may depict a seed account and links 25 connecting the seed account to other nodes (e.g., financial instruments 23, accounts 21). The graph 11 may be used by the network scoring engine 74 to generate the graph result information 252 that is used to characterize the graph 11 as a whole. For example, the graph result information 252 may be embodied as a graph score or a graph rank. In one embodiment the graph score may range from 0 to 100 with the value of 100 representing the highest likelihood of fraud and 0 representing the lowest likelihood of fraud. The graph result information 252 is utilized by the network scoring engine 74 or the scalar scorer module 80 for comparison with the predetermined graph criteria 254 to generate the reporting information 18. For example, a first predetermined graph criteria 254 may be compared with a graph score to identify whether the graph score is greater or lesser than the first predetermined graph criteria 254. The predetermined graph criteria 254 may be generated by an analyst who identifies a particular graph score or graph rank as indicative of fraudulent activity.

FIG. 9 is a block diagram illustrating reporting information 18, according to an embodiment. The reporting information 18 is shown to include scoring information 270 and predetermined alert definitions 274. The reporting information 18 may be generated by the scalar-scorer module 80 and the network scoring engine 74 in response to processing an event 14.

The reporting information 18 may be stored as scoring information 270. Each identity may be associated with scoring information 270. The scoring information 270 may include a probability score information 276, rank score information 278, and raw data information 272. The probability score information 276 may include an identity identifier and a probability score between 0 and 1. For example, the probability score may be a measure of likelihood that the identity has performed a fraudulent activity. The rank score information 278 may include an identity identifier and a rank score between zero and 1,000, the greater value indicating a greater likelihood of fraudulent activity by the identity. The raw data information 272 may include an identity identifier and raw data that is used to generate the probability score information 276 and the rank score information 278. Other embodiments may use other scoring representations to indicate the presence or lack of fraudulent activity for an identity.

The predetermined alert definition 274 may be used to generate and communicate an alert based on the probability score information 276 and/or the rank score information 278 and/or the raw data 272. The predetermined alert definitions 274 may include multiple alert definitions. Each alert definition may include an alert threshold, a scoring information identifier that identifies the particular scoring information 270 that is compared with the alert definition to trigger the alert, and a platform identifier that is used by the fraud detection system 16 to communicate the alert to the appropriate on-line transaction platform 12.

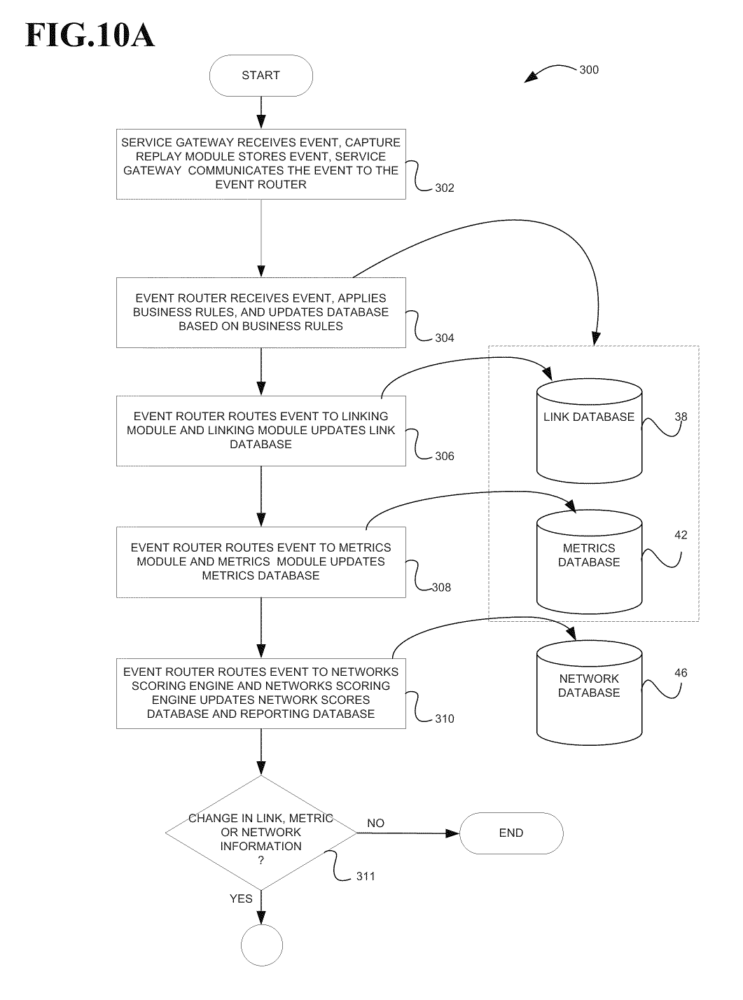

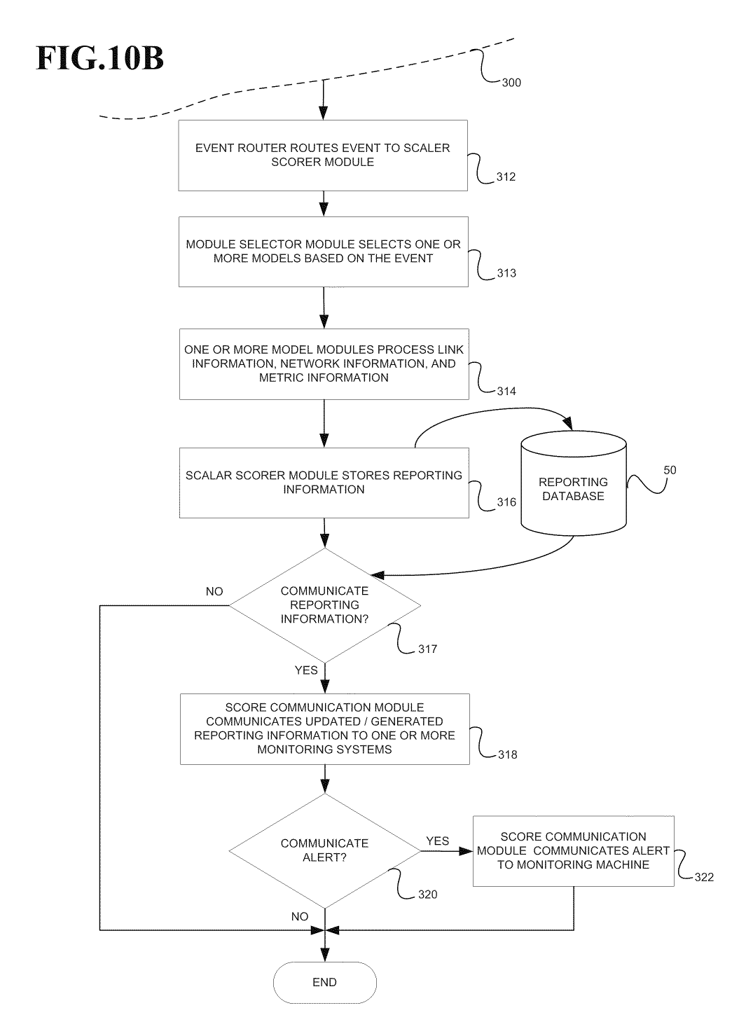

FIGS. 10A and 10B are block diagrams illustrating a method 300, according to one embodiment, to detect and report fraud in real time. The method 300 commences at operation 302 with the service gateway 58 receiving an event 14 from an on-line transaction processing platform 12. For example, the event 14 may include a first identity identifier that identifies a first identity and activity information that identifies a first activity that is performed by the first identity. Next, the service gateway 58 communicates the event 14 to the event router 60.

At operation 304 the event router 60 receives and processes the event 14. For example, the event engine 130 may use the type 100 in the event 14 to identity the appropriate business rules 134 and metrics definitions 136 for application by the event processor 32 to the event 14. The event processor 32 may update or cause the updating of the appropriate link information 36 in the link database 38, and/or the metrics information 40 in the metrics database 42 based on the application of the business rules 134 and the metrics definitions 136 to the event 14. Further, the event router 60 may communicate the event 14 to the capture replay module 62 based on routing rules. If communicated, the capture replay module 62 may store the event 14 in the event database 63.

At operation 306, the event router 60 routes the event 14 to the linking module 70 that, in turn, may further process the event 17 to update the link information 36 in the link database 38 based on the event 14. At operation 308, the event router 60 routes the event 14 to the metrics module 72 that, in turn, may further process the event 17 to update the metrics information 40 in the metrics database 42 based on the event 14. At operation 310, the event router 60 routes the event 14 to the network scoring engine 74 that, in turn, may further process the event 17 to update the network information 44 in the network database 46 based on the event 14. Specifically, the network scoring engine 74 may generate a graph 11 and graph result information 252 based on the graph 11. Further, the network scoring engine 74 may apply the predetermined graph criteria 254 to the graph result information 252, as previously described, to generate reporting information 18 that is stored in the reporting database 50.

At decision operation 311, the event router 60 identifies whether the link information 36, metrics information 40, and/or the network information 44 have changed based on the processing of the event 14. For example, a change may include the addition of a node (e.g., account 21, financial instrument 23) or link 25, the deletion of a node or link 25, or an update to a node or link 25. If the link information 36, metrics information 40, or the network information 44 has changed then a branch is made to operation 312 on FIG. 10B. Otherwise the process ends.

At operation 312, on FIG. 10B, the event router 60 may route the event 14 to the scalar-scorer module 80. At operation 313, the model selector module 150 in the scalar-scorer module 80 uses the type 100 and the payload 102 in the event 14 to identify the appropriate model(s) to process the event 14. For example, the scalar-scorer module 80 may invoke the linear programming module 152, the regression module 154 and the decision tree module 160 to process the event 14 and generate the reporting information 18. Other events may result in using the same or different models. At operation 314, the linear programming module 152, the regression module 154 and the decision tree module 160 may further use the link information 36 and /or the metrics information 40 and/or the network information 44 to generate reporting information 18. The scalar-scorer module 80 may generate/update the reporting information for one or multiple identities based on the single event 14. At operation 316, the scalar scorer module 80 stores the updated/generated reporting information 18 in the reporting database 50.

At decision operation 317, the score communication module 82 identifies whether to communicate the reporting information 18 to one or more of the monitoring machines 26 coupled to the respective on-line transaction processing platforms 12. For example, the score communication module 82 identifies whether reporting information 18 associated with an identity has changed. For example, the score communicating module 82 may identify whether reporting information 18 associated with an identity has increased or decreased. If the reporting information 18 has changed a branch is made to operation 318. Otherwise processing ends.

At operation 318, the score communication module 82 communicates the updated/generated reporting information 18 for one or more identities to one or more monitoring machines 26. For example, the score communication module 82 may utilize the web server 52 and /or the API server 54 to communicate the updated/generated reporting information 18 to one or more monitoring machines 26 that is coupled to an on-line processing platform 12. In one embodiment the score communication module 82 may further communicate reporting information 18 for different identities in response to the processing of a single event 14.

At decision operation 320, the score communication module 82 identifies whether the scoring information 270 or the raw data 272 has exceeded a predetermined alert threshold. If the scoring information 270 has exceeded a predetermined alert threshold then a branch is made to operation 322. Otherwise the process ends. In another embodiment, the same branch to operation 322 may be made based on scoring information 270 that is less than a predetermined alert definition 274.

At operation 322, the score communication module 82 may communicate the alert 28 to the appropriate monitoring machines 26. The alert 28 may include an identity. In one embodiment the score communication module 82 may further communicate more than a single alert 28 with different identities in response to the processing of a single event 14.

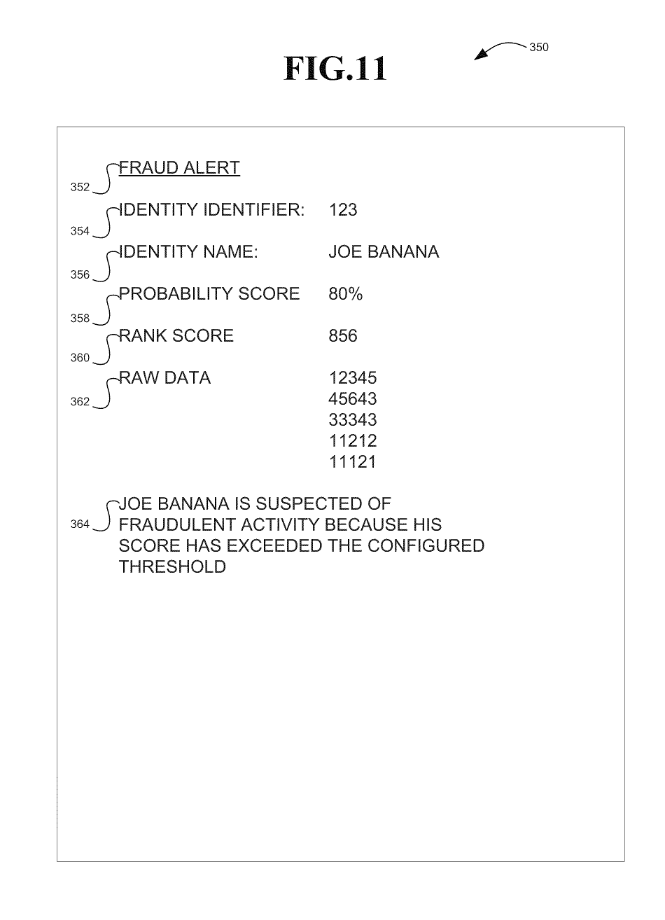

FIG. 11 is a user interface 350, according to an embodiment. The user interface 350 may be used to communicate an alert 28. For example, the user interface 350 may be communicated to one or more on-line transaction platforms 12 in response to the fraud detection system receiving and processing an event 14. The user interface includes a title 352 of “Fraud Alert,” an identity identifier 354 that identifies the identity suspected of fraud, an identity name “Joe Banana” 356, a probability score of “80%” 358, a probability ranking of “856” 360, raw data 362, and a warning 364.

In some embodiments, the method 300 may be implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or, non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between more than one computer system as various software components.

Some example embodiments may include the above illustrated tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language by using a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model, or TCP/IP protocol stack model for defining the protocols used by a network to transmit data.

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

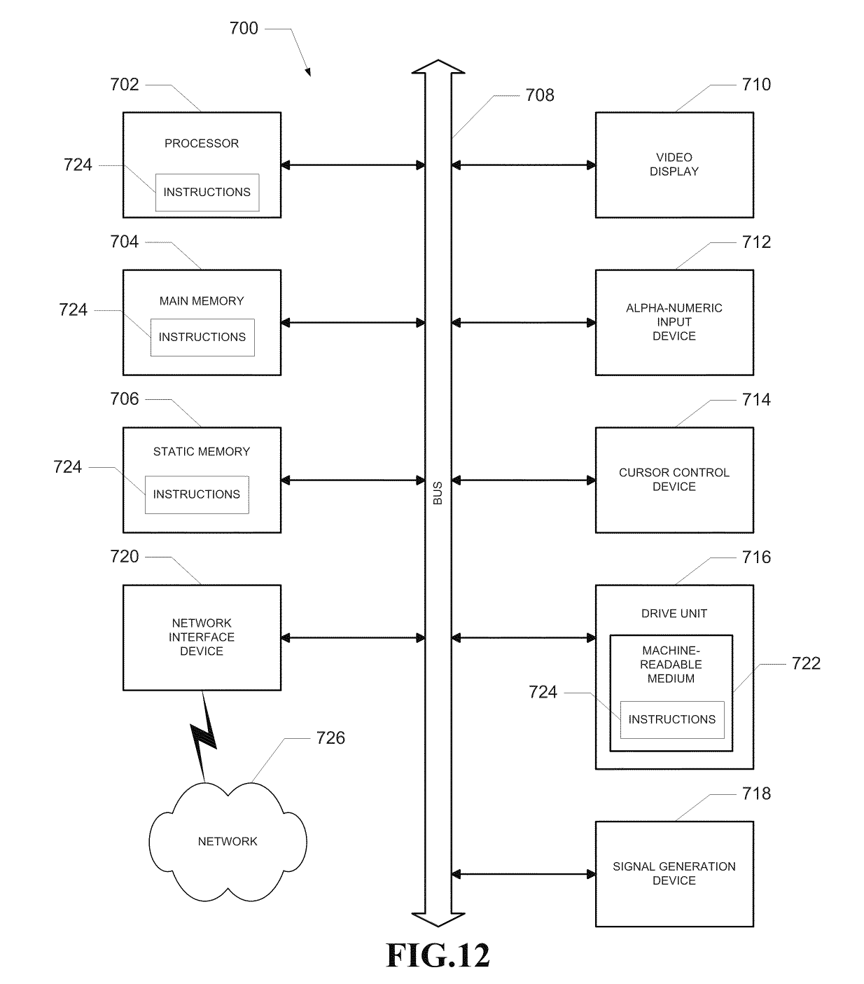

FIG. 12 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g. a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media and magnetic media.

The software may be transmitted over a network using a transmission medium. The term “transmission medium” shall be taken to include any medium that is capable of storing, encoding or carrying instructions for transmission to and execution by the machine, and includes a digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, systems and methods to detect and report fraud in real-time are disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A method of detecting and reporting fraud in real-time, the method comprising:
receiving an event, over a network, from a first on-line transaction processing platform, the event including a first identity identifier that identifies a first identity and information that identifies a first activity performed by the first identity;
generating reporting information based on the event, the generating the reporting information including generating a first score that is associated with the first identity, the first score being a measure of a likelihood that the first identity has performed a fraudulent activity; and
communicating the first score, over the network, to the first on-line transaction processing platform, the communicating the first score in response to the receiving the event.

2. The method of claim 1, further including communicating the first score to a second on-line transaction processing platform, the communicating the first score to the second on-line transaction processing platform in response to the receiving the event.

3. The method of claim 2, wherein the first on-line transaction processing platform is operated by a first legal entity and the second transaction processing platform is operated by a second legal entity, wherein the first and second legal entities are independently controlled.

4. The method of claim 1, wherein the generating the reporting information includes generating a second score that is associated with a second identity, wherein the second score is a measure of a likelihood that the second identity has performed a fraudulent activity

5. The method of claim 4, further including communicating the second score to the first on-line transaction processing platform in response to the receiving the event and communicating the second score to the second on-line transaction processing platform in response to the receiving the event.

6. The method of claim 1, wherein the generating the reporting information based on the event includes retrieving commerce information to generate the reporting information, wherein the commerce information includes a plurality of activities performed by the first identity, wherein the plurality of activities performed by the first identity include a second activity that is performed by the first identity on the first on-line transaction processing platform and a third activity that is performed by the first identity on the second on-line transaction processing platform.

7. The method of claim 6, wherein the event includes identity information that for a first account is hosted by the first on-line transaction platform and wherein the first identity is responsible for the first account.

8. The method of claim 7, wherein the identity information is selected from a group consisting of a social security number, a drivers license number, a credit card number, a bank account number and a brokerage account number.

9. The method of claim 7, wherein the event includes transaction information that is associated with the first account that is hosted by the first on-line transaction platform and wherein the transaction information describes a transaction between the first identity and a second identity.

10. A system to detect and report fraud in real-time, the system comprises:
an event router to receive an event, over a network, from a first on-line transaction processing platform, the event includes a first identity identifier that identifies a first identity and information that identifies a first activity performed by the first identity;
an application server to generate reporting information based on the event, the reporting information includes a first score that is associated with the first identity, the first score is a measure of a likelihood that the first identity has performed a fraudulent activity, the application server to communicate the first score, over the network, to the first on-line transaction processing platform, the first score in response to the receipt of the event.

11. The system of claim 10, wherein the application server is to communicate the first score to a second on-line transaction processing platform in response to the receipt of the event.

12. The system of claim 11, wherein the first on-line transaction processing platform is operated by a first legal entity and the second transaction processing platform is operated by a second legal entity, wherein the first and second legal entities are independently controlled.

13. The system of claim 10, wherein the application server generates a second score that is associated with a second identity, wherein the second score is a measure of a likelihood that the second identity has performed a fraudulent activity

14. The system of claim 13, wherein the application server communicates the second score to the first on-line transaction processing platform in response to the receipt of the event and wherein the application server communicates the second score to the second on-line transaction processing platform in response to the receipt of the event.

15. The system of claim 10, wherein the application server retrieves the commerce information to generate the reporting information, wherein the commerce information includes a plurality of activities performed by the first identity, wherein the plurality of activities performed by the first identity include a second activity that is performed by the first identity on the first on-line transaction processing platform and a third activity that is performed by the first identity on the second on-line transaction processing platform.

16. The system of claim 15, wherein the event includes identity information for a first account that is hosted by the first on-line transaction platform and wherein the first identity is responsible for the first account.

17. The system of claim 16, wherein the identity information is selected from a group consisting of a social security number, a drivers license number, a credit card number, a bank account number and a brokerage account number.

18. The system of claim 16, wherein the event includes transaction information that is associated with the first account that is hosted by the first on-line transaction platform and wherein the transaction information describes a transaction between the first identity and a second identity.

19. A machine-readable medium storing instructions that, when executed by a machine, cause the machine to:
receive an event, over a network, from a first on-line transaction processing platform, the event includes a first identity identifier that identifies a first identity and information that identifies a first activity performed by the first identity;
generate reporting information based on the event, the reporting information includes a first score that is associated with the first identity, the first score is a measure of a likelihood that the first identity has performed a fraudulent activity; and
communicate the first score, over the network, to the first on-line transaction processing platform, the communication of the first score in response to the receiving the event.

20. A system to detect and report fraud in real-time, the system comprises:
a first means to receive an event, over a network, from a first on-line transaction processing platform, the event includes a first identity identifier that identifies a first identity and information that identifies a first activity performed by the first identity;
an application server to generate reporting information based on the event, the reporting information includes a first score that is associated with the first identity, the first score is a measure of a likelihood that the first identity has performed a fraudulent activity, the application server to communicate the first score, over the network, to the first on-line transaction processing platform, the first score in response to the receipt of the event.
